(19) United States
(12) Patent Application Publication
(10) Pub. No.: US 2005/0080821 A1
(43) Pub. Date: Apr. 14, 2005

(54) System and method for managing collections accounts

(76) Inventors: Peter D. Breil, Richmond, VA (US); Bret H. Burleigh, Newmarket, NH (US); Rakesh O. Goyal, Glen Allen, VA (US); Scott A. McGregor, Richmond, VA (US); Bradley S. Morris, Glen Allen, VA (US); Terren J. Peterson, Richmond, VA (US); Harold A. Sell, Glen Allen, VA (US); P. David Spraker JR., Richmond, VA (US)

Correspondence Address: BAKER BOTTS L.L.P., 2001 ROSS AVENUE, SUITE 600, DALLAS, TX, 75201-2980, US

(21) Appl. No.: 10/895,573

(22) Filed: Jul. 21, 2004

Related U.S. Application Data
(60) Provisional application No. 60/489,003, filed on Jul. 21, 2003.

(51) Int. Cl. G06F 7/00

(52) U.S. Cl. 707/104.1

(57) ABSTRACT

A method of managing collections accounts is provided. Data associated with a plurality of collections accounts is received from a plurality of data sources and stored in a first data repository. A plurality of business rules are stored in a business rules database. The plurality of business rules are independent of the plurality of collections accounts. One or more of the plurality of business rules are applied to at least a portion of the stored data to determine whether to initiate one or more particular collections activities regarding one or more of the plurality of collections accounts.

### RELATED APPLICATIONS

This application claims the benefit under 35 U.S.C. § 119(e) of U.S. Provisional Application No. 60/489,003 filed Jul. 21, 2003.

### TECHNICAL FIELD OF THE INVENTION

This invention relates in general to managing credit accounts and, more particularly, to a system and method for managing collections accounts.

### BACKGROUND OF THE INVENTION

A credit account provider/manager may enter particular collections accounts into “collections” when such accounts become delinquent for a particular period of time, over limit by a certain amount, or otherwise problematic for a variety of possible reasons. Such account are typically processed by a collections department of the credit account provider/manager, typically with the goal of bring such accounts back into good standing such that the customer may continue charging on the account and such that the account is not charged off, since such charge-offs represent financial losses to the credit account provider/manager. A collections department may employ a variety of techniques to attempt to bring delinquent, over limit, or otherwise problematic accounts back into good standing. For example, a collections department may attempt to call the customer associated with the account and obtain from the customer a promise to pay, send various letters to the customer, or send the account to an external collections agency.

### SUMMARY OF THE INVENTION

According to one embodiment, a method of managing collections accounts is provided. Data associated with a plurality of collections accounts is received from a plurality of data sources and stored in a collections data repository. A plurality of business rules are stored in a rules database. The plurality of business rules are independent of the plurality of collections accounts. One or more of the plurality of business rules are applied to at least a portion of the stored data to determine whether to initiate one or more particular collections activities regarding one or more of the plurality of collections accounts.

According to another embodiment, another method of managing collections accounts is provided. Data associated with a plurality of collections accounts is received from a plurality of data sources and stored in a first data repository. A plurality of business rules are stored in a business rules database, the plurality of business rules being independent of the plurality of collections accounts. For a particular collections account categorized in a particular segment, data regarding the particular collections account is retrieved from the first data repository and one or more of the plurality of business rules are applied to the retrieved data to: segment the particular collections account into one or more segments based on one or more segmentation criteria; and determine whether to initiate one or more particular collections activities for the particular collections account based at least on the segmentation of that collections account.

According to yet another embodiment, yet another method of managing a customer's debt is provided. A plurality of business rules are stored in a rules database. Data associated with a plurality of accounts is received from a plurality of data sources, the plurality of accounts including collections accounts and non-collections accounts. A first filtering of the received data regarding the collections accounts and non-collections accounts is performed to filter out the data regarding the non-collections accounts. The data regarding the collections accounts, but not the filtered data regarding the non-collections accounts, is communicated to a first data repository for storage. One or more of the plurality of business rules are applied to particular data stored in the first data repository regarding one or more particular collections accounts to determine whether to initiate one or more collections activities regarding the one or more particular collections accounts. The received data regarding the collections accounts and non-collections accounts is also communicated to a second data repository for storage. At least a portion of the data stored in the second data repository is analyzed and one or more of the plurality of rules are modified based on the results of the analysis.

Various embodiments of the present invention may benefit from numerous advantages. It should be noted that one or more embodiments may benefit from some, none, or all of the advantages discussed below.

One advantage of the invention is that systems and methods are provided for making collections-related decisions regarding collections accounts using a set of rules that are customer and account-independent. Business rules may be used to segment collections accounts according to a variety of criteria, and to determine treatment strategies for such accounts based on the segmentation of such accounts. Treatment strategies include various collections activities or strategies that may be implemented or initiated by collections system 100, such as calling a customer manually, calling a customer using a dialer, put an account on an automatic or manual dialer, remove an account from a dialer, sending the customer a variety of types of letters, forwarding an account to an external agency, offering the customer a settlement, or taking no action regarding the account. Particular business rules may be easily added, deleted and modified over time based on analyses regarding the effectiveness of such business rules.

Another advantage is that the collections-related decisions made be made by applying the business rules to data (or a relevant portion of data) received from a variety of data sources, including both “internal” data sources directly associated with or maintained by the credit account management entity (such as a billing division or other system containing customer records, for example) and “external” data sources not directly associated with or maintained by the credit account management entity (such as a credit bureau, for example). In some embodiments, the data is stored centrally such that a decisioning module having access to the business rules may easily access any available data for making collections-related decisions.

In addition, in some embodiments, the data received from the various data sources may also be stored in a long-term data repository such that historical data may be analyzed over time in order to determine the effectiveness of particular business rules or collections strategies. Such business rules or collections strategies may then be modified based on the results of such analyses, thus increasing the efficiency and profitability of the collections system.

Other technical advantages will be readily apparent to one having ordinary skill in the art from the following figures, descriptions, and claims.

### BRIEF DESCRIPTION OF THE DRAWINGS

For a more complete understanding of the present invention and for further features and advantages, reference is now made to the following description, taken in conjunction with the accompanying drawings, in which:

FIG. 1 illustrates an example collections system for managing collections related activity for delinquent, over limit, or otherwise problematic credit accounts in accordance with an embodiment of the invention;

FIG. 2 illustrates a more detailed view of the collections system of FIG. 1 in accordance with a particular embodiment of the present invention;

FIG. 3 illustrates an example process of filtering data received from various data sources in accordance with a particular embodiment of the present invention;

FIG. 4 illustrates an example method for applying business rules to segment and determine collections strategies for collections accounts within a short-term data repository in accordance with a particular embodiment of the invention;

FIG. 5 is an example table illustrating portions of a segmentation hierarchy for determining treatment strategies for collections accounts in accordance with a particular embodiment of the invention;

FIG. 6 illustrates an example method of determining the effects of modifying a particular business rule in accordance with a particular embodiment of the present invention;

FIG. 7 illustrates an example method of tracing and displaying to an analyst the collections activity decision history for a particular collections account in accordance with a particular embodiment of the invention;

FIG. 8 illustrates an example method of managing delinquent and/or over limit accounts in accordance with an embodiment of the invention;

FIG. 9 illustrates an example method of segmenting accounts according to their probability of being cured according to an embodiment of the invention; and

FIG. 10 illustrates a method of managing treatment strategies for collections accounts based on the probability of such collections accounts self-curing and the probability of such collections accounts curing in response to collections activities in accordance with an embodiment of the invention.

### DETAILED DESCRIPTION OF THE DRAWINGS

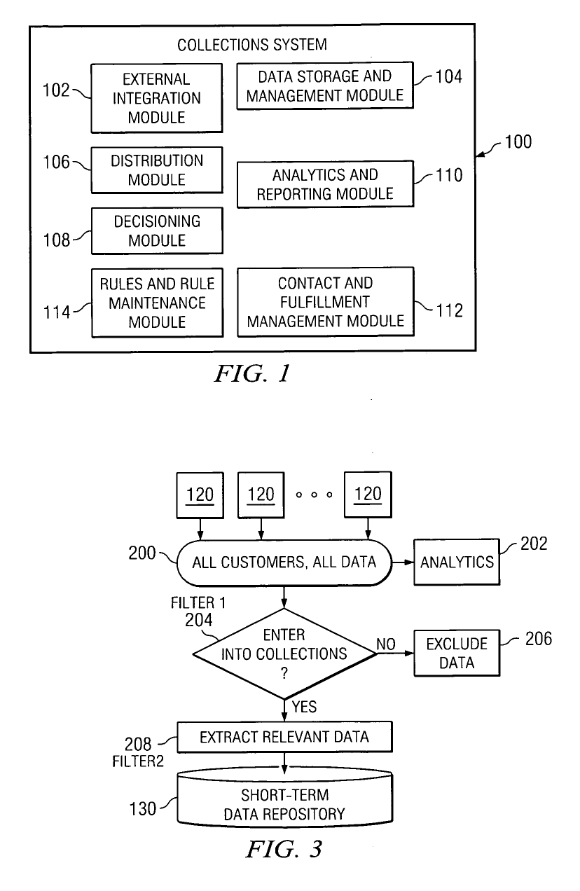

Example embodiments of the present invention and their advantages are best understood by referring now to FIGS. 1 through 10 of the drawings, in which like numerals refer to like parts.

In general, systems and methods are provided for managing customers' credit accounts that have been delinquent for a particular period of time, accounts that are over limit by a particular amount and/or accounts affected by bankruptcy, estate or other hardship issues. In some embodiments, a collections system associated with a credit account management entity (such as a credit card provider, for example) receive data regarding both collections accounts and non-collections accounts from a variety of data sources, including both “internal” data sources directly associated with or maintained by the credit account management entity (such as a billing system or other system containing customer records, for example) and “external” data sources not directly associated with or maintained by the credit account management entity (such as a credit bureau, for example). In some embodiments, data received from such data sources is collected and communicated in parallel to (1) a long-term data repository, where such data may be used for analysis purposes, and (2) a series of filters that allow only collections-related data regarding collections accounts (and not non-collections accounts) to be loaded into a short-term data repository. One or more business rules from a centralized set of business rules are applied to data stored in the short-term data repository in order to make collections-related decisions regarding particular collections accounts, such as whether to initiate a call or letter to a particular customer, or whether to liquidate a particular account, for example. The data stored in the long-term data repository may be analyzed in order to determine the effectiveness of particular business rules or collections strategies, and such business rules or collections strategies may be modified based on the results of such analyses.

In some embodiments, the application of business rules to data stored in the short-term data repository in order to make collections-related decisions includes applying business rules to data regarding particular collections accounts to (1) segment such collections accounts into various segments according to a variety of segmentation criteria (such as the type of account, a credit score for the account, and whether the customer holding the account has been contacted by the account management entity, for example), and (2) determine collections strategies to implement for such collections accounts based at least on the segmentation of such collections accounts. In certain embodiments, particular business rules may be assigned to different segments such that collections accounts may be treated differently based on how they are segmented.

Collections System

FIG. 1 illustrates an example collections system 100 for managing collections-related activity for delinquent, over limit, or otherwise problematic credit accounts (such as accounts affected by bankruptcy, estate or other hardship issues, for example), which may collectively be referred to as collections accounts, in accordance with an embodiment of the invention. Generally, collections system 100 is operable to segment, analyze, test, and apply debt collection strategies to various accounts in collections. For example, collections system 100 may be operable to facilitate the application of various collection strategies to determine the methods to channel a collectable account. Such strategies may be based on business rules, account-scoring processes, and other relevant calculations. Collections system 100 may provide analysts with the ability to develop, test, and promote strategies, have flexible and efficient means to set up multiple scenarios, and have the historical data and analysis tools to both interpret success and aid in new strategy development.

Collections system 100 may provide various functionality, including collection event handling, collection strategy development and maintenance, analysis, and system monitoring. Collection event handling functionality may include system functions that address identification of accounts requiring collections activity, collection and consolidation of requisite data, the application of collection strategies to determine appropriate collection channels, and the routing of accounts to appropriate collection channels (letters, calling, or other customer contact methods). Business rules (strategies created by analysts) may be applied to determine actual account treatment. Letters may also be included in collection activity.

Collection strategy development and maintenance functions may allow analysts to develop and promote collections strategies, set up control groups, maintain scoring models, and maintain business rules and formulas related to strategy application. Collections system 100 may allow for the quick implementation and easy modification of collections strategies. In some situations, the modification of collections strategies may affect the segmentation of accounts; thus, collections system 100 may provide the ability to redecision individual accounts.

Analysis functions may allow analysts to review collections related data such as performance of strategies, treatment allocation to accounts, contact strategies applied and adjuster information for operations. Analysts may use historical data to interpret the success of existing strategies and to aid in development of new strategies. In some embodiments, analysts may run “what if” scenarios to determine the effect of a collection strategy or parameter change before promoting them into production.

Customer contact related functions may involve initiating contact with customers based on a contact channel determined to be appropriate for such customers. Contact channels may include letters and calling, for example. Call center representatives, whether internal or outsourced, may use real-time desktop applications to record and track account related information (such as promises to pay, negotiation of offers, etc.) as they interact with customers. Data derived as a result of collection event handling may be used to drive both outbound calling campaigns and manual calling strategies. Such real-time systems may have access to some or all of the same rules used in the collection event handling process. In some embodiments, during the early stages of account collections, letters may be sent to accountholders in an attempt to recapture delinquent funds.

System monitoring functions may include functions that ensure smooth system operations such as application event logging, error logging, and event notification, for example.

In some embodiments, collections system 100 may reduce or eliminate various problems associated with prior collections handling systems, such as lengthy testing cycles for testing collection strategies, inflexible parameter adjustment capabilities, lack of flexibility for implementing multiple concurrent collection strategies and tests, and difficulty in performing system tests, for example. Such problems associated with prior collections systems may stem from a variety of technical issues, such as business logic existing in multiple systems (such as a decision engine, pre- and post-processors, client applications, and outbound dialer processes, for example) resulting in maintenance problems, duplicate business logic existing in multiple systems creating synchronization issues, a lack of reusable components, and complex implementation involving custom code disbursed in multiple locations in the system, for example.

Collections system 100 may include a variety of function modules operable to perform one or more of the various functions provided by collections system 100. For example, in the embodiment shown in FIG. 1, collections system 100 includes a data integration module 102, a data storage and management module 104, a distribution module 106, a decisioning module 108, an analytics and reporting module 110, a contact and fulfillment management module 112, and a rules and rule maintenance module 114.

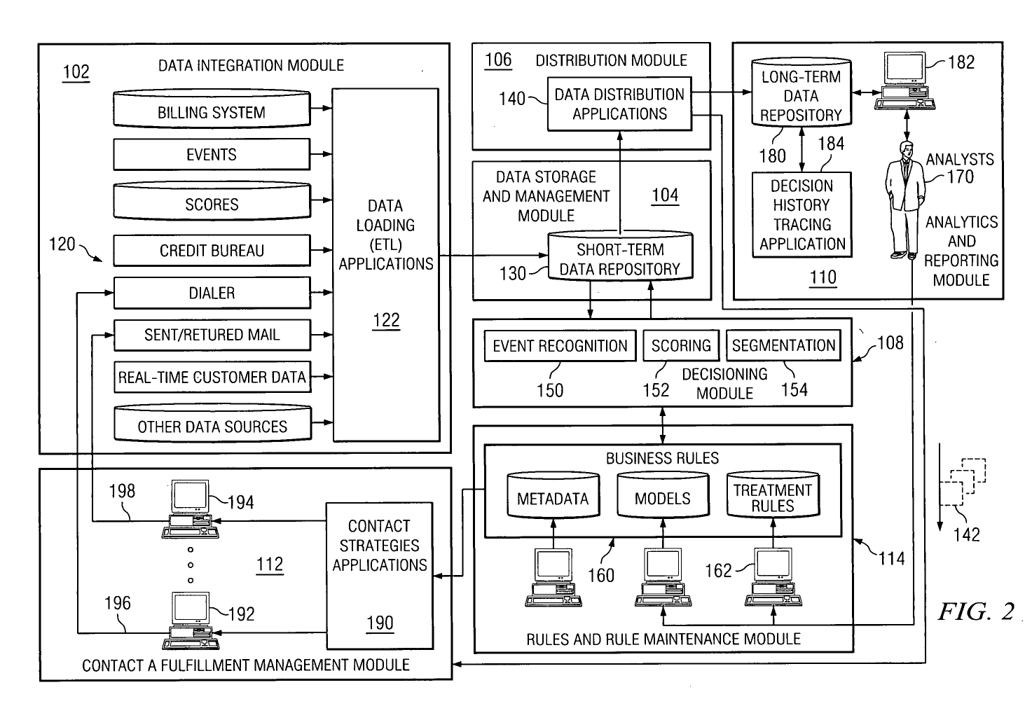

In general, data integration module 102 may merge and/or integrate data from multiple sources, such as data received from a plurality of data sources 120 (discussed below with reference FIG. 2). Data integration module 102 may provide additional information needed for collections event processing. Data integration module 102 may include an extraction, transformation, and load (ETL) layer which moves data from sources to data storage and management module 104. Data storage and management module 104 is generally operable to hold account and collections event data needed for decisioning and routing, and is generally utilized for short term storage of collections data. Data storage and management module 104 may also place data into a holding area for processing. Distribution module 106 may provide formatting and delivery of data to target systems, including contact management and data warehouse. Decisioning module 108 generally provides account-decisioning services by applying collection strategies to collection event accounts. Analytics and reporting module 110 may be used for analysis and reporting on collections strategies and related information. Contact and fulfillment management module 112 may communicate with customer contact mechanisms, such as internal call centers, external call centers, and manual queues, for example, in order to implement various treatment strategies. Rules and rule maintenance module 114 may include business rules used for decisioning and segmenting of accounts. Rules and rule maintenance module 114 may also include applications allowing the modification of rule parameters and decision tables.

Collections system 100 may be maintained by, managed by, or otherwise associated with an account management entity, such as a credit card/credit account provider, a bank, a credit union, an auto loan provider, a student loan lender, a mortgage lender, a home equity loan provider, or a line of credit provider, for example.

FIG. 2 illustrates a more detailed view of collections system 100 in a particular embodiment of the present invention. As discussed above, collections system 100 includes data integration module 102, data storage and management module 104, distribution module 106, decisioning module 108, analytics and reporting module 110, contact and fulfillment management module 112, and rules and rule maintenance module 114 operable to provide the various functions associated with collections system 100.

Each module 102-114 collections system 100 may include software and/or hardware operable to provide the functionality associated with that module 102-114. For example, each function module 102-114 may include one or more computer systems that include appropriate input devices, output devices, mass storage media, processors, memory, or other components for receiving, processing, storing, and/or communicating information with other components of collections system 100. As used in this document, the term “computer” is intended to encompass a server, personal computer, workstation, network computer, wireless data port, wireless telephone, personal digital assistant (PDA), cellular telephone, one or more processors within these or other devices, or any other suitable processing device. Each function module 102-114 may include software or other executable instructions that may be executed by one or more processing units to perform various functions associated with that function module 102-114. Such processing units may comprise any suitable processor(s) that execute various software or other computer instructions associated with function modules 102-114, such as central processing units (CPUs) or other microprocessors, and may include any suitable number of processors working together.

Each function module 102-114 may also include one or more memory units and/or network interfaces. Such memory units may include one or more suitable memory devices, such as one or more random access memories (RAMs), read-only memories (ROMs), dynamic random access memories (DRAMs), fast cycle RAMs (FCRAMs), static RAM (SRAMs), field-programmable gate arrays (FPGAs), erasable programmable read-only memories (EPROMs), electrically erasable programmable read-only memories (EEPROMs), microcontrollers, or microprocessors. The one or more network interfaces may provide an interface between function modules 102-114 and/or between a particular function modules 102-114 and one or more external entities, such as credit bureaus, banks, customers of collections accounts, etc.

Function modules 102-114, as well as the components of each particular function module 102-114, may be located at a single site or, alternatively, at a number of different sites. In addition, function modules 102-114, as well as the components of each particular function module 102-114, may be coupled to each other using one or more links, each of which may include one or more computer buses, local area networks (LANs), metropolitan area networks (MANs), wide area networks (WANs), portions of the Internet, or any other appropriate wireline, optical, wireless, or other links.

As shown in FIG. 2, data integration module 102 comprises a plurality of data sources 120 and a data loading applications 122. Data sources 120 may include one or more data sources maintained by or otherwise associated with the account management entity, such as, for example, a billing system, dialer sources, a returned mail data source, one or more real-time customer data sources and/or other data sources maintained by or otherwise associated with the account management entity. A billing system may include one or more systems of record or databases, such as a scores database including scoring data regarding various accounts (such as relative credit risk scores for various accounts, for example) and a statement data database including data from billing statements or other relevant statements regarding various accounts, for example. Dialer sources may be a source of data obtained from automatic and/or manual dialers contacting or attempting to contact various customers. A returned mail data source may be a source of data obtained from mail returned from customers, such as whether or not the mail was returned unopened (i.e., indicating that the customer moved, for instance) or whether some other feedback was received from customers. Real-time customer data sources may include data sources that receive data from customers in real time (or substantially in real time). For example, data may be received from customers in real time (or substantially in real time) during a phone session with an agent or dialer, or via one or more web sites. Other data sources maintained by or otherwise associated with the account management entity may include, for example, an application data source that comprises data received from customers applying for new accounts or cards, upgrades, etc., such as information regarding such customers' jobs, earnings, and net worth, and debt, for example.

Data sources 120 may also include one or more various data sources distinct from the account management entity, such as one or more credit bureau sources, for example. Credit bureau sources may include data received from one or more credit bureaus regarding various accounts. Such credit bureau data may include a periodic snapshot (such as a monthly snapshot, for example) of various credit bureau attributes for various accounts, or in some embodiments may include a real-time or substantially real-time feed of data from one or more credit bureaus.

Data loading applications 122 may be generally operable to receive and load data from data sources 120 into a data repository associated with data storage and management module 104, discussed below in greater detail. Data loading applications 122 may include extract, transform, and load (ETL) utilities operable to extract data from one or more data sources 120, transform the extracted data, and load the extracted and transformed data into the data repository. Such ETL utilities may be particularly useful for aggregating data from various types of data sources 120 into the data repository. In some embodiments, data loading applications 122 may be operable to extract from data sources 120 particular data relevant to collections and load such collections-related data into the data repository. In some embodiments, some data loads may be the result of data being pushed to the data repository (such as databridge feeds, for example), whereas other data loads may be the result of data being pulled from the data source 120 by data loading applications 122. In particular embodiments, only data regarding accounts in collections (as opposed to the complete universe of accounts maintained by the account provider), which may be referred to as collections accounts, is loaded into and stored in the short-term data repository. Since data being pushed from one or more data sources 120 toward the short-term data repository may include data regarding all accounts maintained by the account provider, particular filtering criteria may be used to ensure that only data regarding collections accounts is loaded into the short-term data repository.

Data storage and management module 104 includes a short-term data repository 130, which may comprise an operational data store for collections data regarding various customers. Short-term data repository 130 may be operable to provide particular data to distribution module 106 for distribution to other modules of collections system 100 and/or to decisioning module 108 as input for various decisioning functions, such as event recognition, scoring and segmentation. Short-term data repository 130 may further include data received from decisioning module 108 (such as data resulting from various decisioning processes, for example), as well as any replicated data that may be used to facilitate the decisioning process. Short-term data repository 130 may be operable to store data temporarily. In some embodiments, short-term data repository 130 may be operable to store data for a predetermined period of time, such as 30 or 60 days, for example, as which time data may be deleted or otherwise removed from short-term data repository 130. Data may be removed on from short-term data repository 130 on a rolling basis, for example. Thus, short-term data repository 130 generally stores current data regarding customer's accounts which may be used for making determinations regarding collections activities (such as whether to trigger a particular collections activity, for example) and then removed after some relatively short time period. As discussed above, short-term data repository 130 may include only data regarding collections accounts, as opposed to other accounts not in collections.

Distribution module 106 includes one or more data distribution applications 140 operable to unload data from short-term data repository 130 to one or more outbound systems, such as analytics and reporting module 110 and contact and fulfillment management module 112, for example. Thus, data distribution applications 140 may be used to transfer data from short-term data repository 130 to long-term data repository 180 of analytics and reporting module 110 for long-term storage. For example, after particular data has been stored within short-term data repository 130 for a predetermined period of time, the data may be transferred from short-term data repository 130 to long-term data repository 180. Such data transfer may be managed by data distribution applications 140. Data distribution applications 140 may also communicate decisions regarding collections activities/strategies to be implemented to contact and fulfillment management module 112 such that such collections activities/strategies may be implemented. For example, in some embodiments, data distribution applications 140 may communicate collections decision files 142 to contact and fulfillment management module 112 that identify particular collections accounts and collections activities/strategies to be implemented for such particular collections accounts. Contact and fulfillment management module 112 may receive such files and initiate the implementation of the identified collections activities/strategies.

Decisioning module 108 includes various applications operable to process data from short-term data repository 130, such as event recognition applications 150, scoring applications 152, and segmentation applications 154. Decisioning applications 150, 152 and/or 154 may access and utilize one or more sets of business rules 160 to process data from short-term data repository 130 for making decisions to process collections accounts, such as determining an appropriate collections strategy (such as whether to call a customer, send the customer a letter, or initiate high-risk account strategies, for example). In some embodiments, decisioning applications 150, 152 and/or 154 make use of business rules 160, business logic and data access in order to process a collections account. Applications 150, 152 and/or 154 may be responsible for gathering data necessary for account scoring and for deciding on collections strategies (such as letter and calling strategies, for example). In some embodiments, other rules-related calculations provided by decisioning module 108 may include determining an appropriate department, the eligibility of particular tools, and particular appropriate outsource agencies for handling particular collections accounts, for example. Applications 150, 152 and/or 154 may be operable to store data resulting from the analysis performed by such applications in short-term data repository 130, such that such data may be stored for bookkeeping purposes and/or distributed via distribution module 106.

Examples of business rules 160 include rules that segment collections accounts by business segment, rules that segment collections accounts by account type, rules that segment collections accounts by various account characteristics, and rules that determine collections activities/strategies for collections accounts based on segmentation of such accounts. Example business segments may be based on FICO scores or other financial scores at the time of the customer applying for his or her account, which scores may affect the product(s) provided to the customer. For instance, example business segments may include sub-prime, non-sub-prime (or up-market), prime and/or super-prime business segments, which refer to the classification of a customer at the time the customers applied for his or her credit account, based at least on the customer's FICO score or other financial scores at the time of application. Account types may include specific types of accounts provided to specific population(s), which types of accounts have any one or more different characteristics. In one embodiment, different account types includes types of accounts associated with different marketing offers communicated to customers. In such embodiment, different account types may include an introductory rate account, a premium rate account, etc. As another example, account types may include gold card accounts, platinum card accounts, airlines miles card accounts, corporate accounts, etc.

Example account characteristics may include account characteristics regarding account balance; the amount of time the account has been in delinquent, over limit, or in collections; the amount (if any) that the account is over limit; the credit limit of the account; various credit scores associated with the account; whether or not the customer associated with the account has been contacted and/or the payment history for the account. Example decisions regarding collections activities/strategies that may be made for collections accounts based on segmentation of such accounts may include whether or not to send the customer a letter (including decisions regarding the particular type of letter), put an account on an automatic or manual dialer, remove an account from a dialer, forward an account to a call center or an external agency, initiate special activities for “high-risk” accounts (such as offering the customer a settlement before the account is charged-off, for example), or do nothing regarding the account. Business rules 160 may include any type of logical rules, such as binary rules or “if-then” rules having any number of potential outcomes, for example. It should be understood that the example business rules 160 discussed above are merely examples, and that any other suitable business rules 160 may be used by decisioning module 108 to make collections-based decisions based on data stored in short-term data repository 130.

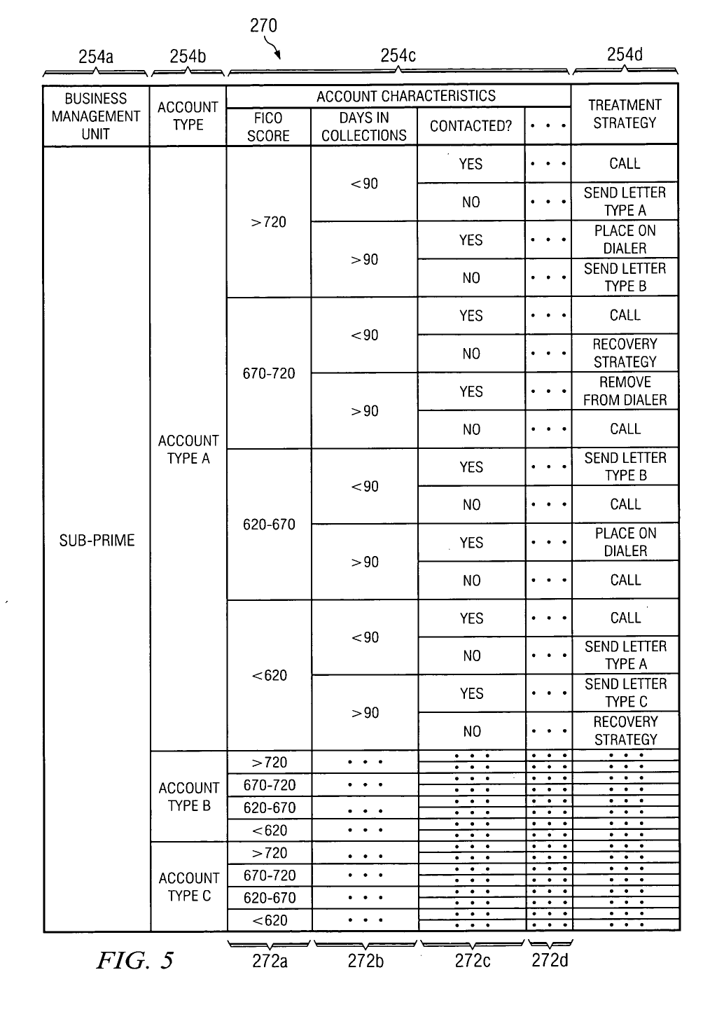

Event recognition applications 150 may be operable to apply various business rules 160 to particular collections data from short-term data repository 130 to determine whether an applicable event has occurred, such as whether an event has occurred that triggers a particular collections strategy, for example, scoring applications 152 may be operable to apply various business rules 160 to collections data in order to score particular collections accounts in one or more areas or according to one or more criteria. Segmentation applications 154 may be operable to apply various business rules 160 to data stored in short-term data repository 130 regarding particular collections accounts to (1) segment such collections accounts into various segments according to a variety of segmentation criteria (such as the type of account, a credit score for the account, and whether the customer holding the account has been contacted by the account management entity, for example), and (2) determine collections strategies to implement for such collections accounts based at least on the segmentation of such collections accounts. Such segmentation is described in greater detail below with reference to FIG. 5.

Rules and rule maintenance module 114 includes business rules 160 which may be applied by decisioning module 108 to data in short-term data repository 130 in order to determine appropriate collections activities for particular collections accounts. Business rules 160 may be centrally stored and/or maintained such that they may be easily accessed and/or modified by analysts 170 via rule management interfaces 162. Rule management interfaces 162 may comprise computer systems that include appropriate input devices, output devices, mass storage media, processors, memory, or other components for receiving, processing, storing, and/or communicating information with other components of collections system 100.

In some embodiments, business rules 160 are product-independent and/or customer-independent such that each business rule 160 could be applied to any collections account in short-term data repository 130 if appropriate. Since business rules 160 are product-independent and/or customer-independent, each business rule 160 may be selected for application to each particular collections accounts, as appropriate. In some embodiments, groups of business rules 160 may be organized and separated by line of business (or other appropriate manner) to keep changes from one set of business rules 160 from affecting other business rules 160. This may allow multiple lines of business to modify business rules 160 without dependencies.

Analytics and reporting module 110 may include a long-term data repository 180 accessible by business analysts 170 via warehouse interfaces 182. Like rule management interfaces 162, long-term data repository interfaces 182 may comprise computer systems that include appropriate input devices, output devices, mass storage media, processors, memory, or other components for receiving, processing, storing, and/or communicating information with other components of collections system 100. In general, analysts 170 may access data from long-term data repository 180 via warehouse interfaces 182 in order to analyze particular business rules 160 (such as measuring the effectiveness of particular business rules 160), perform modeling functions, and create, analyze and/or modify various collections strategies, for example. Analysts 170 may then manage business rules 160 based on the results of their analyses, such as adding, deleting, modifying or otherwise managing individual or groups of business rules 160.

In some embodiments, long-term data repository 180 includes all data received from the data sources 120 regarding all customer accounts, including collections accounts and non-collections accounts, and in some cases, including historical data regarding such accounts. Thus, analysts 170 may analyze business rules 160 and collections strategies based on a very comprehensive set of data. In other embodiments, long-term data repository 180 may include only data regarding collections accounts and not data regarding non-collections accounts.

Contact and fulfillment management module 112 includes contact strategies applications 190 and is operable to implement the collections activities/strategies determined for particular collections accounts by decisioning module 108. In the embodiment shown in FIG. 2, contact strategies applications 190 may receive collections decision files 142 and initiate the implementation of the collections activities/strategies identified by such files 142 for the particular collections accounts identified by such files 142. For example, contact strategies applications 190 may initiate the implementation of collections activities/strategies such as generating and sending a letter, placing an account on an automatic or manual dialer, removing an account from a dialer, forwarding an account to a call center or an external agency, or offering a customer a settlement before the customer's account is charged-off, for example.

In the embodiment shown in FIG. 2, contact and fulfillment management module 112 includes a dialer system 192 and a letter generating system 194. Dialer system 192 may be fully or partially automated and may include one or more dialers, computers, or other suitable hardware and software for calling customers. Similarly, letter generating system 194 may be fully or partially automated and may include one or more computers and/or other suitable hardware and software for generating various types of letters for customers. As indicated by arrows 196 and 198, dialer system 192 and/or letter generating system 194 may communicate various feedback as input into data integration module 102, such as whether or not a customer was contacted/attempted to be contacted by a dialer or whether a letter (as well as the type of the letter) was sent to a customer, for example.

In operation, as shown in FIG. 2, data from a variety of data sources 120 may be loaded into a short-term data repository 130 by data loading (ETL) applications 122, which may serve as a central staging area for such data being collected. As discussed above, in some embodiments data loading applications 122 filter incoming data from data sources 120 such that only particular data regarding collections accounts (and not non-collections accounts) is loaded into short-term data repository 130. In other embodiments, data loading applications 122 may load data regarding all accounts, including collections accounts and non-collections accounts, into short-term data repository 130 and filtering of collections accounts from non-collections accounts may be performed at a later stage.

By loading data from multiple data sources 120 into short-term data repository 130, a comprehensive set of data regarding collections accounts (or in some embodiments, all accounts) may be centrally stored and thus easily accessible to decisioning module 108 and analytics and reporting module 110. Decisioning applications 150, 152 and/or 154 of decisioning module 108 may access particular data from short-term data repository 130, apply various business rules 160 to such accessed data in order to determine appropriate collection activities for particular collections accounts and perform other decisioning analyses, and communicate the results of such analyses back to short-term data repository 130 for storage and/or distribution to other systems via distribution module 106. As discussed in greater detail below with reference to FIG. 5, segmentation applications 154 may apply business rules 160 to collections-related data stored in short-term data repository 130 regarding collections accounts to segment or categorize such collections accounts into a variety of segments or categories according to one or more criteria regarding such accounts, and to determine collections activities/strategies to apply to such accounts based on the segmentation of such accounts. Thus, different business rules 160 may be applied to different collections accounts depending on the segmentation of each collections account. Decisions regarding collections activities to be carried out for particular collections accounts may then be communicated to contact and fulfillment management module 112 in order to carry out the collections activities/strategies determined for the particular collections accounts, as well as to distribution module 106 for distribution to long-term data repository 180.

Data within short-term data repository 130, including data received from data sources 120, data received from decisioning module 108 and/or various historical data regarding collections accounts, may be distributed by data distribution applications 140 to a variety of destinations, including long-term data repository 180 (for analysis by analysts 170) and contact and fulfillment management module 112 (for fulfillment of determined collections activities/strategies). Thus, for example, if decisioning module 108 determines that a particular collections activity is triggered for a particular collections account, data distribution applications 140 may route that determination to contact and fulfillment management module 112 such that the collections activity will be initiated. The data collected in long-term data repository 180 may be analyzed by analysts 170 for a variety of purposes, such as to determine the effectiveness of particular business rules 160 and/or collections strategies, to determine the effectiveness or appropriateness of particular segmentations of collections accounts, to perform various modeling of collections strategies, and to generate reports regarding such analyses. Based on the results of the analyses performed by analysts 170, analysts 170 may add, delete, modify, or otherwise manage one or more particular business rules 160, collections strategies and/or segmentations of particular collections accounts.

In some embodiments, analysts 170 have access to long-term data repository 180, analytics applications, and a simulated copy of business rules 160. An analyst 170 may modify one or more of the simulated business rules, run a series of simulations applying the modified one or more business rules, determine results of the simulations (including determining whether the modifications to the one or more simulated business rules provide an advantage over the unmodified business rules), generating a report identifying the results of the simulations, obtain approval to make the modifications to the actual business rules 160 if such modifications are determined to provide an advantage over the current business rules 160, and make the modifications to the actual business rules 160.

Data Filtering

FIG. 3 illustrates an example process of filtering data received from data sources 120 in accordance with a particular embodiment of the present invention. As discussed above, data sources 120 may provide a comprehensive set of data regarding all customers, including collections accounts and non-collections accounts, indicated in FIG. 3 as data 200. In this embodiment, data 200, including data regarding collections accounts and non-collections accounts, may be forwarded for analytics, as indicated by box 202. With respect to the embodiment of collections system shown in FIG. 2, data 200 may be forwarded to analytics and reporting module 110 such that all data 200 may be available for analytics purposes, such as for analyzing business rules 160, collections strategies, and segmentations of accounts. In parallel, data 200 may be forwarded through a series of one or more filters before being loaded into short-term data repository 130. In an embodiment shown in FIG. 3, a first filter may be applied to data 200 received from data sources 120 to determine whether the account belongs in (or should be entered into) collections, as indicated by box 204. If the incoming data 200 does not belong in collections, the data may be filtered or excluded, as indicated by box 206. Alternatively, if the incoming data 200 is associated with an account that does belong in collections, the data may be forwarded to a second filter to extract relevant data from the incoming data 200, as indicated by box 208.

In some embodiments, the determination at step 204 may be based on multiple factors regarding the collections account. For example, such factors may include one or more risk-based rules or logic based on credit risk criteria (such as FICO scores, for example) regarding the collections account and/or one or more time-based rules or logic based on regarding the time (e.g., number of days) that the collections account has been delinquent, over limit, or otherwise problematic. In particular embodiments, the factors applied in the determination depend upon one or more segmentations of the collections account. For example, in one embodiment in which collections accounts are segmented into sub-prime and non-sub-prime accounts, if an account is segmented into the sub-prime segment, risk-based rules or logic are applied to the account to make the determination, whereas if the account is segmented into the non-sub-prime segment, time-based rules or logic are applied to the account to make the determination.

As discussed above, if it is determined at step 204 that the account does belong in collections, the data may be forwarded to a second filter at step 208 to extract relevant data from the incoming data 200. In one embodiment, extracting relevant data involves extracting data specific to collections activities, for example. Such data passing through both filters (indicated by boxes 204 and 208) may then be loaded into short-term data repository 130. In some embodiments, data loading applications 122 may perform some or all of the filtering functions discussed above.

In this manner, all data regarding all customers received from data sources 120 may be forwarded for analytics purposes, and simultaneously or in parallel, a subset of data regarding collections accounts may be loaded into short-term data repository 130 and used for determining whether to implement particular collections activities, based on the application of particular business rules 160 to such data. Thus, at least a subset of the data received from data sources 120 may be used both for determining appropriate collections activities regarding collections accounts and for analyzing business rules 160 and collections strategies used for determining such collections activities.

Segmenting and Decisioning Collections Accounts

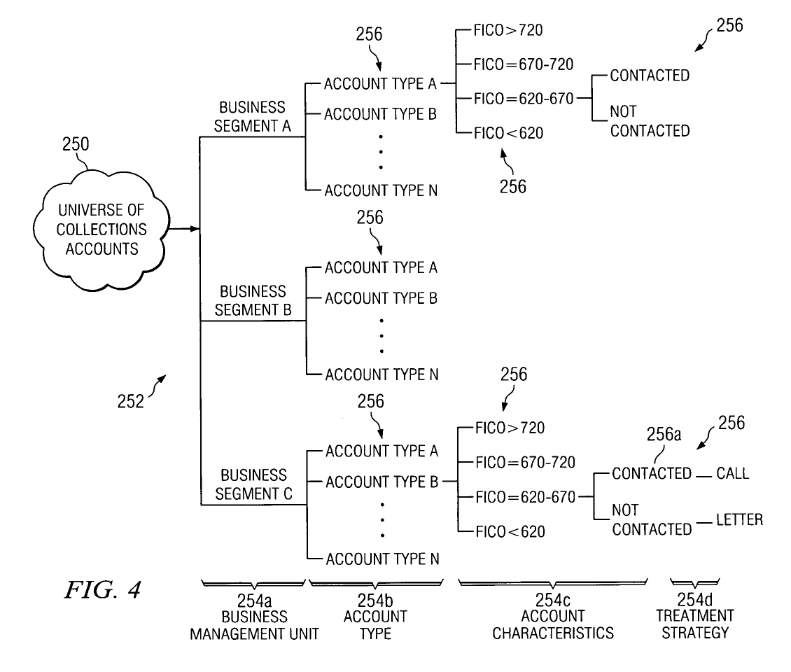

FIG. 4 illustrates an example method for applying business rules 160 to segment and determine collections strategies for collections accounts within short-term data repository 130 in accordance with a particular embodiment of the invention. As shown in FIG. 4, the total universe of collections accounts 250 in short-term data repository 130 may be segmented, or categorized, by the application of business rules 160 according to a hierarchy of segments 252. Segmentation hierarchy 252 includes any number of segmentation levels 254, each defined by one or more associated criteria. In this example embodiment, segmentation hierarchy 252 includes four segmentation levels 254, including a first level 254a regarding the business management unit, or business segment, of collections accounts, a second level 254b regarding the account type of the collections accounts, a third level 254c regarding one or more account characteristics associated with the collections accounts, and a fourth level 254d regarding the appropriate treatment strategies for collections accounts based on the segmentation of such collections accounts.

Each segmentation level may include any suitable number of categories. For example, first segmentation level 254a regarding business management unit may include any number of segments regarding the business segment of the account. For example, business management units may include one or more of sub-prime, non-sub-prime, up-market, prime and super-prime business units. One or more business rules 160 may be designed to segment accounts as defined by first segmentation level 254a.

Each collections account may be further segmented by account type, according to second segmentation level 254b. Second segmentation level 254b may include any number and types of account type segments, such as account types associated with different marketing offers (such as an introductory rate account or a premium rate account, for example) communicated to customers, for example. One or more business rules 160 may be designed to segment accounts as defined by second segmentation level 254b.

Each collections account may be further segmented by one or more account characteristics of the account, according to third segmentation level 254c. Such account characteristics may include, for example, characteristics regarding account balance; the amount of time the account has been in delinquent, over limit, or in collections; the amount (if any) that the account is over limit; the credit limit of the account; various credit scores (e.g., FICO scores) associated with the account; whether or not the customer associated with the account has been contacted and/or the payment history for the account. One or more business rules 160 may be designed to segment accounts as defined by third segmentation level 254c.

The treatment of each collections account may be determined at fourth segmentation level 254d. In particular one or more business rules 160 may be applied to each collections account based at least on the segmentation of that collections account according to first, second and/or third segmentation levels 254a, 254b and 254c. For example, as shown in FIG. 4, for a collections account segmented into segments “Business Segment C” (according to business rules 160 associated with first segmentation level 254a); “Account Type B” (according to business rules 160 associated with second segmentation level 254b); and “FICO score=620-670” and “Contacted,” business rules 160 associated with fourth segmentation level 254d may determine the collections strategy of “Call.” Thus, decisioning module 108 may generate a file 142 identifying the customer and the collections strategy of “Call,” which file 142 may be communicated to contact and fulfillment management module 112, which may initiate a call to the customer. As another example, as shown in FIG. 4, for a collections account segmented into segments “Business Segment C” (according to business rules 160 associated with first segmentation level 254a); “Account Type B” (according to business rules 160 associated with second segmentation level 254b); and “FICO score=620-670” and “Not Contacted,” business rules 160 associated with fourth segmentation level 254d may determine the collections strategy of “Letter.” Thus, decisioning module 108 may generate a file 142 identifying the customer and the collections strategy of “Letter,” which file 142 may be communicated to contact and fulfillment management module 112, which may initiate the generation and sending of a letter to the customer.

In this manner, business rules 160 may be applied to data stored in short-term data repository 130 regarding particular collections accounts to categorize such accounts into a hierarchy of segments 256 (according to the various segmentation levels 254a-254d), and to determine a treatment strategy for such accounts according to such segmentations.

In some embodiments, one or more segmentation levels 254 are defined by criteria regarding the operational relationship between the customer associated with the collections account and the account management entity associated with collections system 100. Such criteria may include the predicted or historical ability of the account management entity in contacting the customer, whether the customer has contacted the account management entity and/or whether the customer has made and/or fulfilled promises to pay, for example.

As another example, one or more segmentation levels 254 may be defined by criteria regarding the likelihood that a customer is contactable by the account management entity. Decisioning module 108 may determine the likelihood that a customer will be contactable based on one or more inputs and/or business rules 160. Such inputs may include the extent to which the customer has been contactable in the past, the number of times the customer has changed addresses, or the length of time since the last contact with the customer, for example.

As discussed above with respect to FIG. 2, collections accounts may be categorized into segments 256 according to business rules 160. Some business rules 160 may be designed only for application within particular segments. For example, a particular business rule 160 may be applied only to accounts segmented in Business Segment B. As another example, a particular business rule 160 may be applied only to accounts segmented in “Business Segment A,” “Account Type C,” and “FICO score <620.”

FIG. 5 is an example table 270 illustrating portions of an example segmentation hierarchy 252 for determining treatment strategies for collections accounts in accordance with a particular embodiment of the invention. In particular, table 270 illustrates only a portion of an example segmentation hierarchy 252 regarding a “Sub-Prime” segment under business management unit segmentation level 254a.

Table 270 illustrates the segmentation of accounts using business rules 160 associated with each of the four segmentation levels 254a-254d, and the treatment of accounts based on such segmentation. It should be understood that each segmentation level 254a-254d may include any number of sub-levels 272. For instance, in the example table 270, segmentation level 254c regarding account characteristics includes sub-levels regarding the account's FICO score (sub-level 272a), number of days in collections (sub-level 272b), and whether the customer has been contacted (sub-level 272a), as well as one or more additional sub-levels indicated by column 272d.

As discussed above, the particular business rules 160 that are associated with each segmentation level 254 or sub-level 272 may be modified over time. For example, one or more new business rules 160 used for a particular segmentation within hierarchy 252 may be added, deleted or modified. Such additions, deletions, or modifications of business rules 160 used for particular segmentation functions may, in some embodiments, be made by analysts 170 as a result of various analysis, modeling, or simulations performed on data within long-term data repository 180. In particular embodiments, particular business rules 160 may be automatically added, deleted or modified over time based on feedback received from analytics and reporting module 110.

In this manner, by segmenting collections accounts into multiple segments or categories according to a set of business rules 160, particular business rules 160 associated with each segmentation level 254 or sub-level 272, or otherwise used for particular segmentations within hierarchy 252 may be easily managed (such as by adding, deleting and/or modifying business rules 160 assigned to particular segments 256). Also, by segmenting and determining the treatment of accounts using business rules 160, the effectiveness or appropriateness of particular business rules 160 may be easily analyzed or measured as compared with previous collections systems.

For example, because the collections accounts in a particular segment 256 may share a number of characteristics (according to the various segmentation levels 254 used for categorizing collections accounts), a particular business rule 160 applied to accounts within a particular segment 256 may be modified and applied to a first portion of collections accounts in that particular segment 256 while the non-modified business rule 160 may be applied to a second portion of collections accounts in that particular segment 256. Thus, the second portion of collections accounts in the particular segment 256 may act as a control group for determining the effects of modifying the particular business rule 160, as discussed in greater detail below.

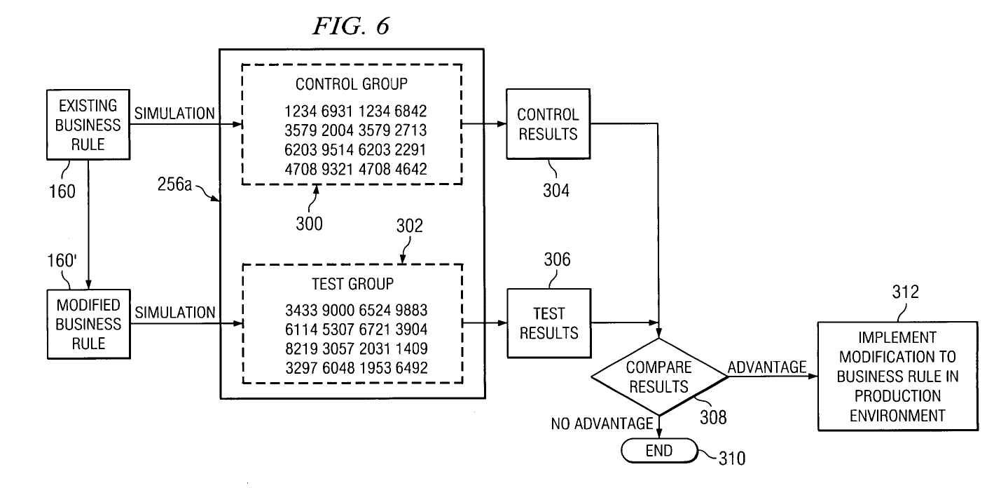

FIG. 6 illustrates an example method of simulating the effects of modifying a particular business rule 160 in accordance with a particular embodiment of the present invention. In this embodiment, the collections accounts within the particular segment 256a are divided into a control group 300 and a test group 302. In this example, of the eight collections accounts in segment 256a, four accounts are assigned to control group 300 and the remaining four accounts are assigned to test group 302. The assignment of four accounts to each of control group 300 and test group 302 is for exemplary purposes only; the collections accounts in a particular segment 256 may be assigned to a control group 300 and a test group 302 in any number and in any suitable manner, such as randomly or according to one or more criteria designed to provide a similar control group 300 and test group 302. In some embodiments, a statistically significant number of accounts are assigned to each of control group 300 and test group 302. As shown in FIG. 6, one or more simulations are run to apply a particular simulated business rule 160 to each of the collections accounts in control group 300. In order to obtain control results 304 the simulated business rule 160 may be a copy or mirror of an actual business rule 160 used by collections system 100 for which the effects of a modification are desired. The proposed modification to the business rule 160 is indicated in FIG. 6 as modified simulated business rule 160′. One or more simulations are run to apply modified simulated business rule 160′ to each collections account in test group 302 in order to obtain test results 306. Control results 304 and test results 306 may include various forms of results regarding collections simulations performed by analysts 170, such as determinations of whether particular collections activities are triggered, whether or not customers would respond to such triggered collections activities, and the simulated financial effects of such collections activities, for example. The various simulations using simulated business rule 160 and modified simulated business rule 160′ may involve various assumptions regarding customer behavior and financial effects of particular actions, for example.

As shown at step 308, control results 304 from the application of simulated business rule 160 to control group 300 are compared with test results 306 from the application of modified simulated business rule 160 to test group 302. In particular, it may be determined whether there are any financial or other advantages associated with the modified simulated business rule 160′ as compared with the simulated business rule 160. If no advantages are determined, the method may end, as shown at step 310. However, if the modified simulated business rule 160′ is determined to be advantageous as compared to simulated business rule 160, the modification may be implemented to the actual business rule 160 in the production environment (i.e., the actual, live environment) corresponding to the simulated business rule 160. In some embodiments, such implementation of the modification to the actual business rule 160 may be made only after an analyst 170 reports the results of his simulation and obtains approval to implement the modification.

By applying a modified business rule to a portion of collections accounts within a particular segment 256 while using another portion of collections accounts in the same segment 256 as a control group, the actual effects of the modification to the business rule may be effectively isolated and thus accurately determined as compared with prior methods of determining the results of modifications to business rules.

Tracing Decision Histories

As discussed above with reference to FIG. 2, in some embodiments, analytics and reporting module 110 includes a decision history tracing application 184 operable to trace the decisioning history regarding particular collections accounts. History tracing application 184 may be further operable to display the decisioning history, including each of the collections activity decisions made regarding a particular collections account, along with each of the various factors (including various scores calculated for the particular collections account) and business rules 160 used for each of such collections activity decisions.

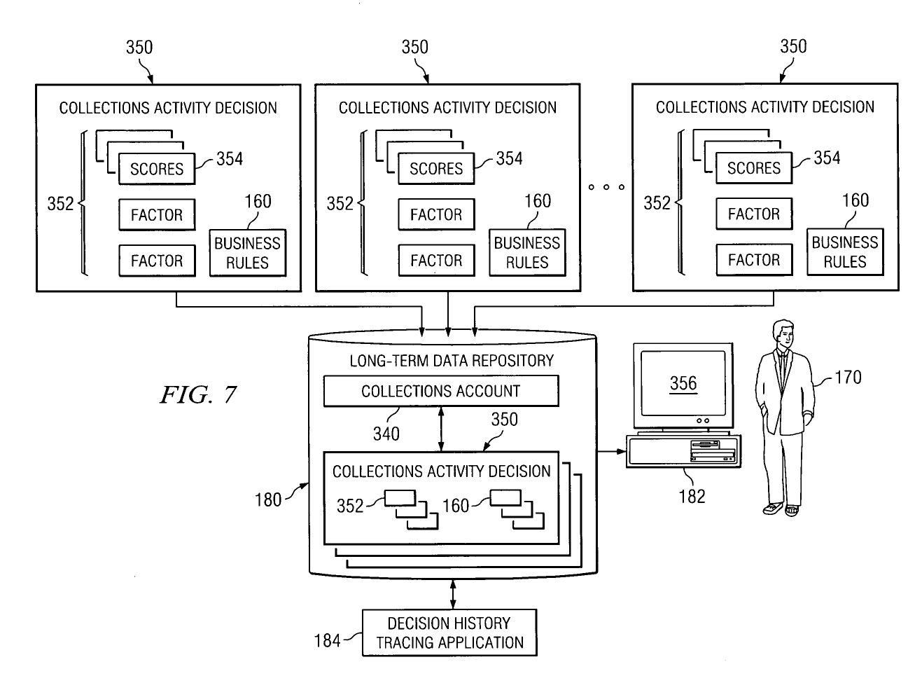

FIG. 7 illustrates an example method of tracing and displaying to an analyst 170 the collections activity decision history for a particular collections account 340 in accordance with a particular embodiment of the invention. Decisions regarding collections activities (such as whether new data regarding the particular collections account triggers a particular collections activity, for example) may be made at various times during the lifespan of the particular collections account within collections system 100. For example, various decisions regarding collections activity for the particular collections account 340, indicated in FIG. 7 as collections activity decisions 350, may be made at regular intervals (such as at the end of every month), or based on new collections-related data being received into short-term data repository 130 from one or more data sources 120.

As shown in FIG. 7, collections activity decisions 350 may be communicated to long-term data repository 180, such as via distribution module 106 (see FIG. 2). Each collections activity decision 350 may have been made by decisioning module 108 based on one or more business rules 160 and other input 352, such as a number of scores 354, various data stored in short-term data repository 130 regarding the particular collections account 340, the segmentation of the particular collections account 340, and any other suitable factors or input for making a collections activity decision. Scores 354 may include various scores calculated by scoring application 152, received from a scores database data input 120, or otherwise determined or obtained regarding the particular collections account 340. In some instances, an algorithm used for making a particular collections activity decision (such as whether a particular collections activity is triggered, for example) includes calculating a number of scores 354 throughout the various steps of the algorithm.

An analyst 170 may submit a request for the collections decision history regarding the particular collections account 340 via long-term data repository interface 182. In response to the request, decision history tracing application 184 may retrieve from long-term data repository and organize each of the collections activity decisions 350 that have been made for the particular collections account 340, including each of the factors 352 (including any scores 354) and business rules 160 used in making each such collections activity decision 350. Decision history tracing application 184 may then display the collections activity decisions 350 for the particular collections account 340 to the analyst 170 via a display 356 associated with long-term data repository interface 182, such as a monitor or printer, for example. In some embodiments, decision history tracing application 184 may generate a display of the collections activity decisions 350 in a timeline or otherwise organized manner. The display may indicate the date, time, and result of each collections activity decision 350, as well as each of the factors 352 (including scores 354) and/or various business rules 160 used in making each collections activity decision 350. In a particular embodiment, decision history tracing application 184 may generate a display of all of the collections activity decisions 350 made regarding the particular collections account 340 since the particular collections account 340 entered collections system 100 until the present time or until the particular collections account 340 exited collections system 100. In a particular embodiment, decision history tracing application 184 may generate a display of the collections activity decisions 350 using an automated flowcharting application (such as MICROSOFT VISIO™ or POWERPOINT™, for example).

Decision history tracing application 184 may generate such displays in real time or substantially in real time. In this manner, an analyst 170 or other user may quickly access the complete history of collections decisions made for a particular collections account. In addition, an analyst 170 or other user may be able to quickly identify which factors 352 are being used and which factors 352 are not being used for decisioning a particular collections account, which may be advantageous from a business perspective. For example, a business analyst may wish to illustrate that a particular factor such as language preference (which may be interpreted as a proxy for ethnic status), for instance, is not being used as a factor in the decisioning of collections accounts. In addition, the historical displays generated by decision history tracing application 184 may be useful for IT personnel for debugging purposes. In particular, the display may allow an IT analyst to identify not only final scores 354 calculated for a collections activity decision 350, but the various scores 354 calculated and used in the various intermediate steps of the decisioning algorithm, which may be particularly helpful for debugging purposes.

Cure Strategies

Collections system 100 may implement a variety of collections strategies for managing collections accounts that enter collections system 100. In some embodiments, such strategies may be designed to minimize financial losses regarding collections accounts. For example, collections system 100 may implement a variety of collections strategies to reduce principal charged off and realize assessed fee income by bringing high-risk customers into collections at the appropriate time, segmenting them in order to apply strategies that alter their behaviors, and driving them to cure or make incremental payments. In addition, in some embodiments, collections system 100 is operable to enable repaid development, testing, deployment, and measurement of collections strategies in order to continually improve collections performance. The term “cure” as used herein refers to the improvement of an account's standing with the account provider/manager. Thus, “curing” an account may comprise bringing an account into good (or better) standing. For example, curing an account in collections may comprise taking actions regarding the account such that the account is removed from collections, or such that the customer is allowed to charge on the account again. Such actions may include, for example, the customer making a minimum (or other) payment on a delinquent account or making a payment on an over-limit account that brings the account balance within the account limit. A “cure strategy” may refer to activities or strategies implemented by collections system 100 in an attempt to cause the customer to cure the collections account, such as calling the customer or sending the customer a letter, for example.

Particular embodiments of collections system 100 employs collections strategies that instead focus on the risk or potential profitability associated with accounts. For example, as discussed below, collections system 100 may determine that an account is likely to self-cure (i.e., cure with minimal or no collections activities/strategies being implemented for the account by collections system 100) and thus does not require a cure strategy, thus saving effort and expenses associated with such a cure strategy. As another example, as discussed below, collections system 100 may determine that an account is almost certain to charge off, and thus it would be financially advantageous to implement one or more recovery activities or strategies rather than attempt to cure the account, again saving effort and expenses associated with attempting to cure the account. Recovery activities or strategies may include collections activities/strategies designed for high-risk accounts and/or accounts that are expected to charge off. In some embodiments, recovery activities/strategies may include various activities/strategies designed to recover as much as possible from a customer whose account will be (or will likely be) charged off, such as offering the customer a settlement to settle the customer's balance, for example.

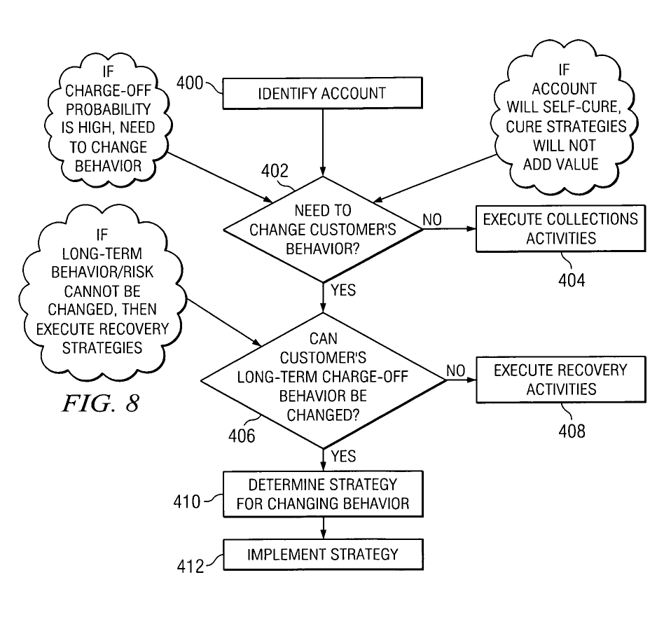

FIG. 8 illustrates an example method of managing delinquent and/or over limit accounts in accordance with an embodiment of the invention. The method may be performed by one or more appropriate modules of collections system 100. In this example embodiment, the method is performed by decisioning module 108. In addition, the method may be triggered when an account enters either pre-collections or collections, depending on the embodiment.

At step 400, decisioning module 108 identifies a particular account in collections or pre-collections, the particular account being associated with a particular customer. The particular account may be identified upon entering collections or pre-collections, as a result of a periodic collections decisioning process, or in response to some action regarding the particular account that triggers a decisioning of the particular account (such as the particular account being 125% over limit or 60 days delinquent, for example), for example. At step 402, decisioning module 108 determines whether the particular customer's behavior needs to be changed. The customer's behavior may refer to various behavior of the customer, such as whether or not the customer makes payments, the size and/or timing of payments made by the customer, whether the customer makes promises to pay, and whether the customer fulfills promises to pay, for example. Decisioning module 108 may make such determination regarding whether the particular customer's behavior needs to be changed based on one or more criteria, which may include one or more business rules 160. In some embodiments, decisioning module 108 may utilize one or more business rules 160 to segment the particular account and determine the treatment for the account, such as discussed above regarding FIG. 5.

In particular embodiments, decisioning module 108 may determine (1) the probability that the customer will charge off the balance of the account; and (2) the probability that the customer will self-cure the account (i.e., without the implementing of a cure strategy by collections system 100). Decisioning module 108 may use the results of these determinations in determining whether the particular customer's behavior needs to be changed. For example, if the determined probability that the customer will charge off the balance of the account is above a particular threshold, decisioning module 108 may determine that the customer's behavior needs to be changed. However, if the determined probability that the customer will self-cure the account is above a particular threshold, decisioning module 108 may determine that any attempt to implement a cure strategy would not add value (i.e., would not be financially advantageous) to the credit account management entity. If decisioning module 108 determines that the customer's behavior need not be changed (for example, if the customer's determined charge-off probability is low or the customer's determined self-cure probability is high), decisioning module 108 may determine to leave the particular account in collections (or pre-collections) and execute one or more various collections activities or strategies based on the application of various business rules 160, as shown at step 404. Alternatively, if decisioning module 108 determines that the customer's behavior does need to be changed (for example, if the customer's determined charge-off probability is high and the customer's determined self-cure probability is low), the method may advance to step 406.

At step 406, decisioning module 108 predicts whether the particular customer's charge-off behavior can be changed. Decisioning module 108 may make such determination regarding whether the particular customer's behavior can be changed based on one or more criteria, which may include one or more business rules 160. In some embodiments, decisioning module 108 may utilize one or more business rules 160 in order to segment the account regarding whether the particular customer's behavior can be changed, such as discussed above regarding FIG. 5. In addition, decisioning module 108 may make the determination at step 406 based on input such as the history of the customer's past behavior and whether or not the customer can be contacted, for example.

If decisioning module 108 determines at step 406 that the customer's behavior cannot be changed, decisioning module 108 may determine to initiate one or more particular recovery activities or strategies for the particular account at step 408. For example, decisioning module 108 may determine to initiate a settlement offer to the customer in order to recover as much as possible from a customer whose account will be (or will likely be) charged off. Alternatively, if decisioning module 108 determines that the customer's behavior can be changed, the method may advance to step 410. At step 410, decisioning module 108 may determine a strategy for attempting to change the particular customer's behavior. As with the determinations made at steps 402 and 406, such determination may be based on one or more criteria, which may include one or more business rules 160. For example, the strategy may include attempting to call the customer employing a dialer, attempting to call the customer manually, sending a letter to the customer and/or offering the customer an incentive to make a payment or cure his delinquent and/or over limit account. At step 412, the determined strategy may be implemented by collections system 100.

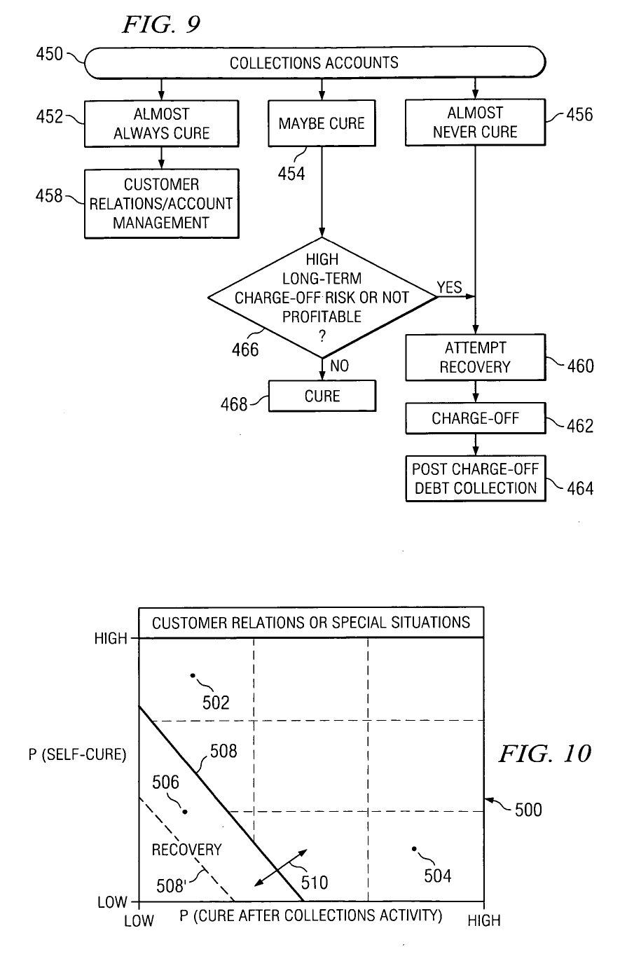

FIG. 9 illustrates an example method of segmenting accounts according to their probability of being cured according to an embodiment of the invention. Generally, collections system 100 may be operable to determine the probability of whether each of a plurality of collections accounts will cure, segment each collections account accordingly, and applying one of a number of collections strategies to each collections account based at least in part on the segment into which that collections account was categorized.

As shown in FIG. 9, each of a plurality of collections accounts 450 is analyzed and segmented into one of three segments, or categories: an almost always cure segment 452, a maybe cure segment 454, and an almost never cure segment 456. In this embodiment, decisioning module 108 may segment each collections account 450 into one of segments 452, 454 and 456 based on one or more criteria, such as various data regarding the collections account 450 (such as the type of the account, the credit limit and current balance of the account, whether the account is delinquent and/or over limit, the amount, if any, that the account is over limit, the amount of time the account has been delinquent and/or over limit, for example) and/or the customer associated with the collections account 450 (such as the customer's capital or salary, for example), whether the customer is contactable, and the customer's payment history, for example. In some embodiments, one or more business rules 160 may be applied to various data regarding collections accounts 450 in determining the segment 452, 454 or 456 for each collections account 450.

In some embodiments, decisioning module 108 may determine a probability, score or other objective measurement of the probability or likelihood of collections accounts 450 curing. Thus, each segment 452, 454 and 456 may correspond with a particular range of probabilities, scores or other objective measurement determined for collections accounts 450 by decisioning module 108. In the embodiment shown in FIG. 9, if the determined measure of curing for a collections account 450 is above an upper threshold, the collections account 450 is categorized in the almost always cure segment 452. If the determined measure of curing for a collections account 450 is below a lower threshold, the collections account 450 is categorized in the almost never cure segment 456. If the determined measure of curing for a collections account 450 is between the upper threshold and the lower threshold, the collections account 450 is categorized in the maybe cure segment 454.

As discussed above, different collections strategy may be applied to collections accounts 450 categorized in the different segments 452, 454 and 456. For example, as shown in FIG. 9, for collections accounts 452 categorized in the almost always cure segment 452, decisioning module 108 may determine to implement one or more customer relations and/or account management strategies for the account, as shown at step 458. Customer relations strategies may include passive management of the account, which may include not implementing any collections activities for the account, for example. Account management strategies may include managing one or more characteristics of the account, such as lowering the limit for the account, for example.

For collections accounts 456 categorized in the almost never cure segment 456, decisioning module 108 may determine to implement a strategy to attempt a recovery strategy for the account, as shown at step 460. As discussed above, such strategy may include communicating a settlement offer to the customer (or taking some other action) in order to recover as much as possible from a customer whose account will be (or will likely be) charged off. If such strategy fails, and the account is charged off at step 462 (for example, if the account remains delinquent after, say, 180 days), decisioning module 108 may determine to implement strategies for post-charge-off debt collection, as shown at step 464.

For each collections account 450 categorized in the maybe cure segment 454, decisioning module 108 may make a determination at step 466 regarding whether (a) the collections account 450 is a high risk for long-term charge-off and/or (b) it would not be profitable for the collections system to attempt to cure the collections account 450. Decisioning module 108 may make such determinations based on any suitable criteria and/or data, including one or more business rules 160. In addition, like various other determinations discussed herein, the determination made at step 466 may involve determining the probability of various results based on a variety of assumptions (such as assumptions regarding customer behavior, for example). If decisioning module 108 determines that (a) the collections account 450 is not a high risk for long-term charge-off and (b) it would be profitable for the collections system to attempt to cure the collections account 450, a “cure” collections strategy may be applied to the collections account 450, as shown at step 468. Thus, collections system 100 may implement one or more strategies in an attempt to get the customer to cure his delinquent or over limit account 450. Alternatively, if decisioning module 108 determines either that (a) the collections account 450 is a high risk for long-term charge-off or (b) it would not be profitable for the collections system to attempt to cure the collections account 450, the method may proceed to step 460 to implement a recovery strategy for the account.

FIG. 10 illustrates a method of managing treatment strategies for collections accounts in accordance with an embodiment of the invention. Collections system 100 may manage liquidation strategies for collections accounts based at least on an analysis of the probability of such collections accounts curing over time. For example, as shown in graph 500, collections system 100 may determine whether to liquidate or attempt to cure a collections account based at least on two inputs: (1) the probability that the collections account will self-cure, as indicated along the y-axis of graph 500, and (2) the probability that the collections account will cure in response to various collections activities initiated by collections system 100, as indicated along the x-axis of graph 500. Each probability may be determined based on any one or more various data and/or business rules 160. The determined probabilities may then be plotted on graph 500 to determine the appropriate collections strategy: implement a recovery strategy or implement a cure strategy.

For example, if it is determined for a particular collections account, the probability that the account will self-cure is relatively high, while the probability that the account will cure in response to collections activities initiated by collections system 100 is relatively low, as indicated by data point 502 in graph 500, the appropriate collections strategy would be to attempt to cure the account. As another example, if it is determined for a particular collections account, the probability that the account will self-cure is relatively low, while the probability that the account will cure in response to collections activities initiated by collections system 100 is relatively high, as indicated by data point 504 in graph 500, the appropriate collections strategy would be to attempt to cure the account. As another example, if it is determined for a particular collections account, the probability that the account will self-cure is relatively low, and the probability that the account will cure in response to collections activities initiated by collections system 100 is also relatively low, as indicated by data point 506 in graph 500, the appropriate collections strategy would be to liquidate the account.

As shown in graph 500, the appropriate collections strategy may be defined at least in part by a line 508 separating the different collections strategies (recovery and cure). In some embodiments, the parameters of line 508 may depend on the particular account being processed. For example, in a particular embodiment, line 508 may be the default line and line 508′ may be used for accounts qualifying as special situations, such as accounts affected by bankruptcy, estate, or other hardship issues, for example. Any number of lines may be used for various accounts. In addition, line 508 may be adjusted over time, such as based on analyses performed by analysts 170, as indicated by arrow 510. For example, if analysts 170 determine that recovery strategies are being applied to too many accounts, line 508 may be moved to the left (i.e., toward example line 508′) to reduce the number of account being selected for recovery strategies. Such adjustments to line 508 may be made to increase the profitability of collections system 100.

Although an embodiment of the invention and its advantages are described in detail, a person skilled in the art could make various alternations, additions, and omissions without departing from the spirit and scope of the present invention as defined by the appended claims.

1. A method of managing collections accounts, comprising:
receiving data associated with a plurality of collections accounts from a plurality of data sources;
storing the received data in a first data repository;
storing a plurality of business rules in a business rules database, wherein the plurality of business rules are independent of the plurality of collections accounts; and
applying one or more of the plurality of business rules to at least a portion of the stored data to determine whether to initiate one or more particular collections activities regarding one or more of the plurality of collections accounts.

2. The method of claim 1, wherein receiving data associated with a plurality of collections accounts from a plurality of data sources and storing the received data comprises:
receiving from a plurality of data sources data associated with a plurality of accounts including a plurality of collections accounts and a plurality of non-collections accounts;
performing a first filtering of the received data to filter out the data associated with the plurality of non-collections accounts; and
storing the data associated with the plurality of collections accounts, but not the filtered data associated with the plurality of non-collections accounts, in the first data repository.

3. The method of claim 2, wherein:
the received data associated with the plurality of collections accounts includes collections-related data and non-collections-related data;
the method further comprises performing a second filtering of the data associated with the plurality of collections accounts to filter out the non-collections-related data; and
storing the data associated with the plurality of collections accounts in the first data repository comprises storing the collections-related data associated with the plurality of collections accounts, but not the filtered non-collections-related data associated with the plurality of collections accounts, in the first data repository.

4. The method of claim 1, wherein the plurality of data sources comprises one or more data sources associated with an account management entity and one or more external data sources.

5. The method of claim 1, wherein:
the one or more data sources associated with an account management entity include one or more of the following:
a billing system associated with an account management entity;
a system of record for a billing system;
a system of record for a collections system;
a dialer system; and
an account scores database; and
the one or more external data sources include one or more credit bureaus.

6. The method of claim 1, further comprising:
modifying a first version of a particular business rule to create a second version of the particular business rule;
applying the second version of the particular business rule to a first set of one or more of the plurality of collections accounts;
determining results of the application of the second version of the particular business rule; and
managing the particular business rule based at least on the determined results of the application of the second version of the particular business rule.

7. The method of claim 6, wherein managing the particular business rule based at least on the determined results of the application of the second version of the particular business rule comprises determining whether to implement the first version or the second version of the particular business rule for subsequent application of the particular business rule.

8. The method of claim 6, further comprising:
performing the modifying, applying, and determining steps in a test environment; and
performing the management step in a production environment.

9. The method of claim 6, further comprising:
applying the first version of the particular business rule to a second set of one or more of the plurality of collections accounts;
determining results of the application of the first version of the particular business rule;
comparing the determined results of the application of the first version of the particular business rule with the determined results of the application of the second version of the particular business rule; and
managing the particular business rule based at least on the comparison of the determined results of the application of the first version of the particular business rule with the determined results of the application of the second version of the particular business rule.

10. The method of claim 9, wherein:
comparing the determined results of the application of the first version of the particular business rule with the determined results of the application of the second version of the particular business rule comprises determining whether the second version of the particular business rule provides a financial advantage compared to the first version of the particular business rule; and
managing the particular business rule based at least on the comparison of the determined results of the application of the first version of the particular business rule with the determined results of the application of the second version of the particular business rule comprises implementing the second version of the particular business rule for subsequent application of the particular business rule if the second version of the particular business rule provides a financial advantage compared to the first version of the particular business rule.

11. The method of claim 9, wherein the first set of one or more of the plurality of collections accounts and the second set of one or more of the plurality of collections accounts comprise the same collections accounts.

12. The method of claim 1, wherein applying one or more of the plurality of business rules to at least a portion of the stored data to determine whether to initiate one or more particular collections activities regarding one or more of the plurality of collections accounts comprises applying one or more business rules to at least a portion of the stored data regarding one or more of the plurality of collections accounts to segment the one or more collections accounts into a plurality of segments according to one or more criteria.

13. The method of claim 12, further comprising determining whether to initiate one or more particular collections activities for each of the one or more collections accounts based on the segmentation of that collections account.

14. The method of claim 12, wherein applying one or more business rules to at least a portion of the stored data regarding one or more of the plurality of collections accounts to segment the one or more collections accounts into a plurality of segments according to one or more criteria comprises, for each of the one or more collections accounts:
using one or more first business rules to segment the collections account by business management unit;
using one or more second business rules to segment the collections account by account type;
using one or more third business rules to segment the collections account by account characteristics; and
using one or more fourth business rules to determine a treatment segment for the collections account.

15. The method of claim 1, further comprising:
communicating the received data for storage in a second data repository;
analyzing at least a portion of the data stored in the second data repository; and
managing at least one of the plurality of business rules based on the results of the analysis.

16. The method of claim 15, wherein:
the first data repository is a short-term data repository; and
the second data repository is a long-term data repository.

17. The method of claim 15, wherein managing at least one of the plurality of business rules comprises adding, deleting, or modifying at least one of the plurality of business rules.

18. The method of claim 15, wherein:
analyzing at least a portion of the data stored in the second data repository comprises:
simulating a modification of a particular business rule in a test environment;
simulating an application of the simulated modified particular business rule to one or more of the plurality of collections accounts;
determining results of the simulations using the simulated modified particular business rule;
determining whether to implement the modification to the particular business rule in a production environment based on the results of the simulations; and
managing at least one of the plurality of business rules comprises implementing the modification to the particular business rule in the production environment.

19. The method of claim 18, wherein:
the plurality of business rules comprise a plurality of actual business rules;
simulating a modification of a particular business rule in a test environment comprises modifying a simulated instance of a particular one of the actual business rules;
implementing the modification to the particular business rule in a production environment comprises implementing the modification to the particular actual business rule; and
the method further comprises applying the modified particular actual business rule to at least a portion of the stored data in the production environment to determine whether to initiate one or more particular collections activities regarding one or more of the plurality of collections accounts.

20. The method of claim 19, wherein the method further comprises:
simulating an application of the simulated instance of the actual business rule to one or more of the plurality of collections accounts;
determining results of the simulations using the simulated actual business rule; and
comparing the results of the simulations using the simulated actual business rule to the results of the simulations using the simulated modified business rule; and
wherein determining whether to implement the modification to the particular business rule based on the results of the simulations comprises determining whether to implement the modification to the particular business rule based at least on the comparison of the results of the simulations using the simulated actual business rule to the results of the simulations using the simulated modified business rule.

21. The method of claim 1, further comprising:
for each of a plurality of instances over time, applying one or more business rules to data regarding a particular collections account to:
calculate one or more scores regarding the particular collections account; and
determine whether to initiate one or more particular collections activities regarding the particular collections account based on a set of factors including the one or more calculated scores; and
for each of the plurality of instances over time, storing each of the collections activities determinations and the set of factors used for each collections activities determination, including the one or more calculated scores; and
in response to a request from a user that identifies the particular collections account, initiating a tracing tool operable to:
retrieve from storage the collections activities determinations and the set of factors used for each collections activities determination, including the one or more calculated scores; and
display to the user the retrieved collections activities determinations and the factors used for each collections activities determination, including the one or more calculated scores.

22. The method of claim 1, further comprising:
for a particular collections account, determining a first objective measurement of the likelihood that the customer associated with the particular collections account will cure the particular collections account without the implementation of one or more collections activities, where customer curing the particular collections account comprises the customer acting to bring the particular collections account into good standing;
for the particular collections account, determining a second objective measurement of the likelihood that the customer will cure the particular collections account in response to the implementation of one or more collections activities; and
determining whether to implement one or more particular collections activities regarding the particular collections accounts based at least on the first and second objective measurements.

23. The method of claim 22, wherein determining whether to initiate one or more particular collections activities regarding the particular collections accounts based at least on the first and second objective measurements comprises determining whether to implement one or more recoveries-related collections activities or one or more cure-related collections activities based at least on the first and second objective measurement, the one or more recoveries-related collections activities comprising collections activities for high-risk account.

24. A method of managing collections accounts, comprising:
receiving data associated with a plurality of collections accounts from a plurality of data sources;
storing the received data in a first data repository;
storing a plurality of business rules in a business rules database, the plurality of business rules being independent of the plurality of collections accounts; and
for a particular collections account categorized in a particular segment:
retrieve from the first data repository data regarding the particular collections account; and
apply one or more of the plurality of business rules to the retrieved data to:
segment the particular collections account into one or more segments based on one or more segmentation criteria; and
determine whether to initiate one or more particular collections activities for the particular collections account based at least on the segmentation of that collections account.

25. The method of claim 24, wherein applying one or more of the plurality of business rules to the retrieved data to segment each of the plurality of collections accounts into one or more segments based on one or more segmentation criteria comprises applying one or more business rules to segment the particular collections account into a hierarchy of segmentation levels, each segmentation level defined by one or more corresponding segmentation criteria.

26. The method of claim 25, wherein applying one or more business rules to segment the particular collections account into a hierarchy of segmentation levels comprises:
applying one or more first business rules to segment the particular collections account by business management unit;
applying one or more second business rules to segment the particular collections account by account type; and
applying one or more third business rules to segment the particular collections account by one or more account characteristics.

27. The method of claim 26, wherein applying one or more first business rules to segment the particular collections account by business management unit comprises segmenting the particular collections account into a sub-prime segment or a non-sub-prime segment.

28. The method of claim 26, wherein applying one or more third business rules to segment the particular collections account by one or more account characteristics comprises segmenting the particular collections account based at least on a numerical score reflecting the credit risk of the particular collections account.

29. The method of claim 24, wherein:
one or more steps of the method are performed by an account management entity; and
the one or more segmentation criteria include at least one criteria regarding the operational relationship between the customer associated with the collections account and the account management entity.

30. The method of claim 29, wherein the at least one criteria regarding the operational relationship between the customer associated with the collections account and the account management entity comprises a criteria regarding the ability of the account management entity to contact the customer.

31. The method of claim 24, further comprising:
for a particular collections account associated with a particular customer, determining an objective measurement of the likelihood that the particular customer may be contacted; and
wherein the one or more segmentation criteria include at least one criteria regarding the objective measurement of the likelihood that the particular customer may be contacted.

32. The method of claim 24, further comprising:
for a particular collections account, determining an objective measurement of the likelihood that the account will be brought into good standing;
wherein the one or more segmentation criteria include at least one criteria regarding the objective measurement of the account will be brought into good standing.

33. The method of claim 24, further comprising:
for a particular collections account, determining an objective measurement of the likelihood that the account will be account will be brought into good standing;
if the determined objective measurement is above an upper threshold, categorizing the particular collections account in a first segment;
if the determined objective measurement is below a lower threshold, categorizing the particular collections account in a second segment;
if the determined objective measurement is between the upper threshold and the lower threshold, categorizing the particular collections account in a third segment; and
determining whether to initiate one or more particular collections activities for the particular collections account based at least on the whether the particular collections account is categorized into the first, second or third segment.

34. The method of claim 24, wherein receiving data associated with a plurality of collections accounts from a plurality of data sources and storing the received data comprises:
receiving from a plurality of data sources data associated with a plurality of accounts including a plurality of collections accounts and a plurality of non-collections accounts;
performing a first filtering of the received data to filter out the data associated with the plurality of non-collections accounts; and
storing the data associated with the plurality of collections accounts, but not the filtered data associated with the plurality of non-collections accounts, in the first data repository.

35. The method of claim 34, wherein:
the received data associated with the plurality of collections accounts includes collections-related data and non-collections-related data;
the method further comprises performing a second filtering of the data associated with the plurality of collections accounts to filter out the non-collections-related data; and
storing the data associated with the plurality of collections accounts in the first data repository comprises storing the collections-related data associated with the plurality of collections accounts, but not the filtered non-collections-related data associated with the plurality of collections accounts, in the first data repository.

36. The method of claim 24, further comprising:
communicating the received data for storage in a second data repository;
analyzing at least a portion of the data stored in the second data repository; and
managing at least one of the plurality of business rules based on the results of the analysis.

37. The method of claim 24, further comprising:
for each of a plurality of instances over time, applying one or more business rules to data regarding a particular collections account to:
calculate one or more scores regarding the particular collections account; and
determine whether to initiate one or more particular collections activities regarding the particular collections account based on a set of factors including the one or more calculated scores; and
for each of the plurality of instances over time, storing each of the collections activities determinations and the set of factors used for each collections activities determination, including the one or more calculated scores; and
in response to a request from a user that identifies the particular collections account, initiating a tracing tool operable to:
retrieve from storage the collections activities determinations and the set of factors used for each collections activities determination, including the one or more calculated scores; and
display to the user the retrieved collections activities determinations and the factors used for each collections activities determination, including the one or more calculated scores.

38. A method of managing collections accounts, comprising:
storing a plurality of business rules in a business rules database;
receiving data associated with a plurality of accounts from a plurality of data sources, the plurality of accounts including collections accounts and non-collections accounts;
performing a first filtering of the received data regarding the collections accounts and non-collections accounts to filter out the data regarding the non-collections accounts;
communicating the data regarding the collections accounts, but not the filtered data regarding the non-collections accounts, to a first data repository for storage;
applying one or more of the plurality of business rules to particular data stored in the first data repository regarding one or more particular collections accounts to determine whether to initiate one or more collections activities regarding the one or more particular collections accounts;
communicating the received data regarding the collections accounts and non-collections accounts to a second data repository for storage;
analyzing at least a portion of the data stored in the second data repository; and
modifying one or more of the plurality of business rules based on the results of the analysis.

39. The method of claim 38, further comprising applying at least one of the modified business rules to particular data stored in the first data repository regarding one or more particular collections accounts to determine whether to initiate one or more collections activities regarding the one or more particular collections accounts.

40. The method of claim 38, wherein the plurality of business rules are independent of the plurality of collections accounts.

41. The method of claim 38, wherein the steps of performing a first filtering of the received data regarding the collections accounts and non-collections accounts and communicating the received data regarding the collections accounts and non-collections accounts to a second data repository for storage are performed in parallel.

42. The method of claim 38, wherein
the first data repository is a short-term data repository; and
the second data repository is a long-term data repository.

43. The method of claim 38, further comprising automatically removing data from storage in the first data repository after a predetermined time period.

44. The method of claim 38, further comprising:
copying the received data regarding the collections accounts and non-collections accounts to provide a first instance of the received data and a second instance of the received data;
wherein performing a first filtering of the received data comprises performing a first filtering of the first instance of the received data; and
wherein communicating the received data to a second data repository for storage comprises communicating a second instance of the received data to a second data repository for storage.

45. The method of claim 44, wherein:
the received data associated with the plurality of collections accounts includes collections-related data and non-collections-related data;
the method further comprises performing a second filtering of the first instance of the received data to filter out the non-collections-related data; and
communicating the data regarding the collections accounts, but not the filtered data regarding the non-collections accounts, to a first data repository for storage comprises communicating the collections-related data regarding the collections accounts, but not the data regarding the non-collections accounts filtered according to the first filtering or the non-collections related data filtered according to the second filtering, to the first data repository for storage.

46. A system for managing collections accounts, comprising:
a data integration module operable to receive data associated with a plurality of collections accounts from a plurality of data sources;
a data storage module operable to store the received data in a first data repository;
a business rules module operable to store a plurality of business rules in a business rules database, wherein the plurality of business rules are independent of the plurality of collections accounts; and
a decisioning module operable to apply one or more of the plurality of business rules to at least a portion of the stored data to determine whether to initiate one or more particular collections activities regarding one or more of the plurality of collections accounts.

47. The system of claim 46, wherein receiving data associated with a plurality of collections accounts from a plurality of data sources and storing the received data comprises:
receiving from a plurality of data sources data associated with a plurality of accounts including a plurality of collections accounts and a plurality of non-collections accounts;
performing a first filtering of the received data to filter out the data associated with the plurality of non-collections accounts; and
communicating the data associated with the plurality of collections accounts, but not the filtered data associated with the plurality of non-collections accounts, to the data storage module for storage.

48. The system of claim 47, wherein:
the received data associated with the plurality of collections accounts includes collections-related data and non-collections-related data;
the data integration module is further operable to perform a second filtering of the data associated with the plurality of collections accounts to filter out the non-collections-related data; and
communicating the data associated with the plurality of collections accounts to the data storage module for storage comprises communicating the collections-related data associated with the plurality of collections accounts, but not the filtered non-collections-related data associated with the plurality of collections accounts, to the data storage module for storage.

49. The system of claim 46, wherein the plurality of data sources comprise one or more data sources associated with an account management entity and one or more external data sources.

50. The system of claim 46, wherein:
the one or more data sources associated with an account management entity include one or more of the following:
a billing system associated with an account management entity;
a system of record for a billing system;
a system of record for a collections system;
a dialer system; and
an account scores database; and
the one or more external data sources include one or more credit bureaus.

51. The system of claim 46, wherein:
the business rules module is further operable to receive a modification of a first version of a particular business rule to create a second version of the particular business rule;
the decisioning module is further operable to apply the second version of the particular business rule to a first set of one or more of the plurality of collections accounts;
the system further comprises an analytics module operable to:
determine results of the application of the second version of the particular business rule; and
manage the particular business rule based at least on the determined results of the application of the second version of the particular business rule.

52. The system of claim 51, wherein managing the particular business rule based at least on the determined results of the application of the second version of the particular business rule comprises determining whether to implement the first version or the second version of the particular business rule for subsequent application of the particular business rule.

53. The system of claim 51, wherein:
the decisioning module is operable to apply the first version of the particular business rule to a second set of one or more of the plurality of collections accounts; and
the analytics module operable to:
determine results of the application of the first version of the particular business rule;
compare the determined results of the application of the first version of the particular business rule with the determined results of the application of the second version of the particular business rule; and
manage the particular business rule based at least on the comparison of the determined results of the application of the first version of the particular business rule with the determined results of the application of the second version of the particular business rule.

54. The system of claim 53, wherein:
comparing the determined results of the application of the first version of the particular business rule with the determined results of the application of the second version of the particular business rule comprises determining whether the second version of the particular business rule provides a financial advantage compared to the first version of the particular business rule; and
managing the particular business rule based at least on the comparison of the determined results of the application of the first version of the particular business rule with the determined results of the application of the second version of the particular business rule comprises implementing the second version of the particular business rule for subsequent application of the particular business rule if the second version of the particular business rule provides a financial advantage compared to the first version of the particular business rule.

55. The system of claim 53, wherein the first set of one or more of the plurality of collections accounts and the second set of one or more of the plurality of collections accounts comprise the same collections accounts.

56. The system of claim 46, wherein:
the data integration module is further operable to communicate the received data for storage in a second data repository; and
the analytics module is operable to:
analyze at least a portion of the data stored in the second data repository; and
manage at least one of the plurality of business rules based on the results of the analysis.

57. The system of claim 56, wherein
the first data repository is a short-term data repository; and
the second data repository is a long-term data repository.

58. The system of claim 56, wherein managing at least one of the plurality of business rules comprises adding, deleting, or modifying at least one of the plurality of business rules.

59. The system of claim 56, wherein:
analyzing at least a portion of the data stored in the second data repository comprises:
simulating a modification of a particular business rule in a test environment;
simulating an application of the simulated modified particular business rule to one or more of the plurality of collections accounts;
determining results of the simulations using the simulated modified particular business rule;
determining whether to implement the modification to the particular business rule in a production environment based on the results of the simulations; and
managing at least one of the plurality of business rules comprises causing the modification of the particular business rule to be implemented in the production environment.

60. The system of claim 59, wherein:
the plurality of business rules comprise a plurality of actual business rules;
simulating a modification of a particular business rule in a test environment comprises modifying a simulated instance of a particular one of the actual business rules;
implementing the modification to the particular business rule in a production environment comprises implementing the modification to the particular actual business rule; and
the decisioning module is operable to apply the modified particular actual business rule to at least a portion of the stored data in a the production environment to determine whether to initiate one or more particular collections activities regarding one or more of the plurality of collections accounts.

61. The system of claim 60, wherein:
the analytics module is operable to:
simulate an application of the simulated instance of the actual business rule to one or more of the plurality of collections accounts;
determine results of the simulations using the simulated actual business rule; and
compare the results of the simulations using the simulated actual business rule to the results of the simulations using the simulated modified business rule; and
determining whether to implement the modification to the particular business rule based on the results of the simulations comprises determining whether to implement the modification to the particular business rule based at least on the comparison of the results of the simulations using the simulated actual business rule to the results of the simulations using the simulated modified business rule.

62. The system of claim 46, wherein:
the analytics module is operable, for each of a plurality of instances over time, to apply one or more business rules to data regarding a particular collections account to:
calculate one or more scores regarding the particular collections account; and
determine whether to initiate one or more particular collections activities regarding the particular collections account based on a set of factors including the one or more calculated scores;
the data storage module is operable to store, for each of the plurality of instances over time, each of the collections activities determinations and the set of factors used for each collections activities determination, including the one or more calculated scores; and
the analytics module is further operable to initiate, in response to a request from a user that identifies the particular collections account, a tracing tool operable to:
retrieve from storage the collections activities determinations and the set of factors used for each collections activities determination, including the one or more calculated scores; and
display to the user the retrieved collections activities determinations and the factors used for each collections activities determination, including the one or more calculated scores.

63. The system of claim 46, wherein the decisioning module is operable, for a particular collections account, to:
determine a first objective measurement of the likelihood that the customer associated with the particular collections account will cure the particular collections account without the implementation of one or more collections activities, where customer curing the particular collections account comprises the customer acting to bring the particular collections account into good standing
determine a second objective measurement of the likelihood that the customer will cure the particular collections account in response to the implementation of one or more collections activities; and
determine whether to initiate one or more particular collections activities regarding the particular collections accounts based at least on the first and second objective measurements.

64. The system of claim 63, wherein determining whether to initiate one or more particular collections activities regarding the particular collections accounts based at least on the first and second objective measurements comprises determining whether to implement one or more recoveries-related collections activities or one or more cure-related collections activities based at least on the first and second objective measurement, the one or more recoveries-related collections activities comprising collections activities for high-risk account.

65. The system of claim 63, wherein determining whether to initiate one or more particular collections activities regarding the particular collections accounts based at least on the first and second objective measurements comprises determining whether to liquidate or attempt to cure the particular collections accounts based at least on the first and second objective measurements.

66. A system of managing collections accounts, comprising:
a data integration module operable to receive data associated with a plurality of collections accounts from a plurality of data sources;
a data storage module operable to store the received data in a first data repository;
a rule module operable to store a plurality of business rules in a business rules database, the plurality of business rules being independent of the plurality of collections accounts; and
a decisioning module operable, for a particular collections account categorized in a particular segment, to:
retrieve from the first data repository data regarding the particular collections account; and
apply one or more of the plurality of business rules to the retrieved data to:
segment the particular collections account into one or more segments based on one or more segmentation criteria; and
determine whether to initiate one or more particular collections activities for the particular collections account based at least on the segmentation of that collections account.

67. The system of claim 66, wherein applying one or more of the plurality of business rules to the retrieved data to segment each of the plurality of collections accounts into one or more segments based on one or more segmentation criteria comprises applying one or more business rules to segment the particular collections account into a hierarchy of segmentation levels, each segmentation level defined by one or more corresponding segmentation criteria.

68. The system of claim 67, wherein applying one or more business rules to segment the particular collections account into a hierarchy of segmentation levels comprises:
applying one or more first business rules to segment the particular collections account by business management unit;
applying one or more second business rules to segment the particular collections account by account type; and
applying one or more third business rules to segment the particular collections account by one or more account characteristics.

69. The system of claim 68, wherein applying one or more first business rules to segment the particular collections account by business management unit comprises segmenting the particular collections account into a sub-prime segment or a non-sub-prime segment.

70. The system of claim 68, wherein applying one or more third business rules to segment the particular collections account by one or more account characteristics comprises segmenting the particular collections account based at least on a numerical score reflecting the credit risk of the particular collections account.

71. The system of claim 66, wherein:
the decisioning module is associated with an account management entity; and
the one or more segmentation criteria include at least one criteria regarding the operational relationship between the customer associated with the collections account and the account management entity.

72. The system of claim 71, wherein the at least one criteria regarding the operational relationship between the customer associated with the collections account and the account management entity comprises a criteria regarding the ability of the account management entity to contact the customer.

73. The system of claim 66, wherein:
the decisioning module is further operable to determine, for a particular collections account associated with a particular customer, an objective measurement of the likelihood that the particular customer may be contacted; and
wherein the one or more segmentation criteria include at least one criteria regarding the objective measurement of the likelihood that the particular customer may be contacted.

74. The system of claim 66, wherein:
the decisioning module is further operable to determine, for a particular collections account, an objective measurement of the likelihood that the account will be brought into good standing; and
wherein the one or more segmentation criteria include at least one criteria regarding the objective measurement of the likelihood that the account will be brought into good standing.

75. The system of claim 66, wherein the decisioning module is further operable to:
determine, for a particular collections account, an objective measurement of the likelihood that the account will be brought into good standing;
if the determined objective measurement is above an upper threshold, categorizing the particular collections account in a first segment;
if the determined objective measurement is below a lower threshold, categorizing the particular collections account in a second segment;
if the determined objective measurement is between the upper threshold and the lower threshold, categorizing the particular collections account in a third segment; and
determine whether to initiate one or more particular collections activities for the particular collections account based at least on the whether the particular collections account is categorized into the first, second or third segment.

76. The system of claim 66, wherein receiving data associated with a plurality of collections accounts from a plurality of data sources and storing the received data comprises:
receiving from a plurality of data sources data associated with a plurality of accounts including a plurality of collections accounts and a plurality of non-collections accounts;
performing a first filtering of the received data to filter out the data associated with the plurality of non-collections accounts; and
communicating the data associated with the plurality of collections accounts, but not the filtered data associated with the plurality of non-collections accounts, to the data storage module for storage.

77. The system of claim 76, wherein:
the received data associated with the plurality of collections accounts includes collections-related data and non-collections-related data;
the data integration module is further operable to perform a second filtering of the data associated with the plurality of collections accounts to filter out the non-collections-related data; and
communicating the data associated with the plurality of collections accounts to the data storage module for storage comprises communicating the collections-related data associated with the plurality of collections accounts, but not the filtered non-collections-related data associated with the plurality of collections accounts, to the data storage module for storage.

78. The system of claim 66, wherein:
the data integration module is further operable to communicate the received data for storage in a second data repository; and
the analytics module is further operable to:
analyze at least a portion of the data stored in the second data repository; and
manage at least one of the plurality of business rules based on the results of the analysis.

79. The system of claim 66, wherein:
the decisioning module is operable, for each of a plurality of instances over time, to apply one or more business rules to data regarding a particular collections account to:
calculate one or more scores regarding the particular collections account; and
determine whether to initiate one or more particular collections activities regarding the particular collections account based on a set of factors including the one or more calculated scores; and
the data storage module is operable, for each of the plurality of instances over time, to store each of the collections activities determinations and the set of factors used for each collections activities determination, including the one or more calculated scores; and
the analytics module is further operable, in response to a request from a user that identifies the particular collections account, to initiate a tracing tool operable to:
retrieve from storage the collections activities determinations and the set of factors used for each collections activities determination, including the one or more calculated scores; and
display to the user the retrieved collections activities determinations and the factors used for each collections activities determination, including the one or more calculated scores.

80. A system of managing collections accounts, comprising:
a business rules module operable to store a plurality of business rules in a business rules database;
a data integration module operable to:
receive data associated with a plurality of accounts from a plurality of data sources, the plurality of accounts including collections accounts and non-collections accounts;
perform a first filtering of the received data regarding the collections accounts and non-collections accounts to filter out the data regarding the non-collections accounts;
communicate the data regarding the collections accounts, but not the filtered data regarding the non-collections accounts, to a first data repository for storage; and
communicate the received data regarding the collections accounts and non-collections accounts to a second data repository for storage;
a decisioning module operable to apply one or more of the plurality of business rules to particular data stored in the first data repository regarding one or more particular collections accounts to determine whether to initiate one or more collections activities regarding the one or more particular collections accounts; and
an analytics module operable to:
analyze at least a portion of the data stored in the second data repository; and
modify one or more of the plurality of business rules based on the results of the analysis.

81. The system of claim 80, wherein the decisioning module is further operable to apply at least one of the modified business rules to particular data stored in the first data repository regarding one or more particular collections accounts to determine whether to initiate one or more collections activities regarding the one or more particular collections accounts.

82. The system of claim 80, wherein the plurality of business rules are independent of the plurality of collections accounts.

83. The system of claim 80, wherein the data integration module is operable to perform the first filtering of the received data regarding the collections accounts and non-collections accounts and communicate the received data regarding the collections accounts and non-collections accounts to a second data repository for storage in parallel.

84. The system of claim 80, wherein
the first data repository is a short-term data repository; and
the second data repository is a long-term data repository.

85. The system of claim 80, further comprising automatically removing data from storage in the first data repository after a predetermined time period.

86. The system of claim 80, wherein:
the data integration module is operable to copy the received data regarding the collections accounts and non-collections accounts to provide a first instance of the received data and a second instance of the received data;
performing a first filtering of the received data comprises performing a first filtering of the first instance of the received data; and
communicating the received data to a second data repository for storage comprises communicating a second instance of the received data to a second data repository for storage.

87. The system of claim 86, wherein:
the received data associated with the plurality of collections accounts includes collections-related data and non-collections-related data;
the data integration module is further operable to perform a second filtering of the first instance of the received data to filter out the non-collections-related data; and
communicating the data regarding the collections accounts, but not the filtered data regarding the non-collections accounts, to the first data repository for storage comprises communicating the collections-related data regarding the collections accounts, but not the data regarding the non-collections accounts filtered according to the first filtering or the non-collections related data filtered according to the second filtering, to the first data repository for storage.
